(19) United States
(12) Patent Application Publication
(10) Pub. No.: US 2007/0009095 A1
(43) Pub. Date: Jan. 11, 2007

(54) Bearing mechanism and X-ray tube

(75) Inventors: Ram Turaga, Bangalore (IN); George Parampil, Bangalore (IN)

Correspondence Address: PATRICK W. RASCHE;ARMSTRONG TEASDALE LLP, ONE METROPOLITAN SQUARE, SUITE 2600, ST. LOUIS, MO, 63102-2740, US

(73) Assignee: GE Medical Systems Global Technology Company, LLC

(21) Appl. No.: 11/481,091

(22) Filed: Jul. 5, 2006

(30) Foreign Application Priority Data
Jul. 7, 2005 (JP) 2005-198473

(51) Int. Cl. H01J 35/00

(52) U.S. Cl. 378/132

(57) ABSTRACT

With a view to providing a bearing mechanism exhibiting a high leakage preventing effect for a liquid medium and an X-ray tube having such a bearing mechanism, the bearing mechanism includes a gap between a plain bearing and a shaft, with a liquid medium being present in the gap, the gap comprising at least three concentric annular gaps communicating in series with one another. The shaft has a pumping groove formed in an outer periphery surface thereof at a position facing the gap. The liquid medium is a liquid metal. The liquid metal is gallium or an alloy thereof.

### CROSS REFERENCE TO RELATED APPLICATIONS

This application claims the benefit of Japanese Application No. 2005-198473 filed Jul. 7, 2005.

### BACKGROUND OF THE INVENTION

The present invention relates to a bearing mechanism and an X-ray tube. Particularly, the present invention is concerned with a bearing mechanism including a gap between a plain bearing and a shaft, with a liquid medium being present in the gap, as well as an X-ray tube having such a bearing mechanism.

The X-ray tube includes within a vacuum vessel a cathode, an anode, a rotor integral with the anode, and a bearing mechanism which supports a shaft of the rotor. A liquid medium for improving thermal conductivity, lubrication, damping and electric conductivity is sealed in the bearing mechanism. As the liquid medium there is used gallium or an alloy thereof.

The bearing mechanism has a structure able to prevent leakage of the liquid medium because the high voltage stability is impaired if the liquid medium leaks into vacuum. The leakage is prevented by a spiral rotation of a pumping groove formed in the shaft to push back the liquid medium (see, for example, Patent Literature 1).

[Patent Literature 1] U.S. Pat. No. 6,377,658 (Columns 1-4, FIGS. 1-3)

In case of preventing the leakage in the above manner, a relation is created such that the inside of a double cylinder rotates as a result of rotation of the shaft inside the bearing, and Taylor vortices are produced in the liquid medium. Consequently, the liquid medium layer becomes unstable and the leakage preventing effect of the pumping groove is deteriorated.

### SUMMARY OF THE INVENTION

Therefore, it is an object of the present invention to provide a bearing mechanism which is highly effective in preventing the leakage of a liquid medium, and an X-ray tube having such a bearing mechanism.

In a first aspect of the present invention for solving the above-mentioned problem there is provided a bearing mechanism including a gap between a plain bearing and a shaft, with a liquid medium being present in the gap, wherein the gap comprises at least three concentric annular gaps communicating in series with one another.

In a second aspect of the present invention for solving the above-mentioned problem there is provided an X-ray tube including, within a vacuum vessel, a cathode, an anode, a rotor integral with the anode, and a bearing mechanism which supports a shaft of the rotor, wherein the bearing mechanism includes a gap between a plain bearing and the shaft, with a liquid medium being present in the gap, and the gap comprises at least three concentric annular gaps communicating in series with one another.

For pushing back the liquid medium it is preferable for the shaft to have a pumping groove formed in an outer periphery surface thereof at a position facing the gap.

In point of thermal and electric conductivities it is preferable for the liquid medium to be a liquid metal.

It is preferable for the liquid metal to be gallium or an alloy thereof because of having a low vapor pressure property.

For enhancing the mechanical strength of the shaft supporting portion it is preferable for the bearing mechanism to further include a rolling bearing on the shaft at a position different from the position of the plain bearing.

It is preferable for the bearing mechanism to support the shaft in a cantilevered fashion because bearings can be concentrated to one place.

It is preferable for the bearing mechanism to support the shaft in a straddled fashion because a load can be dispersed.

According to the present invention in the above-mentioned aspects thereof, the bearing mechanism has a gap between a plain bearing and a shaft, with a liquid medium being present in the gap, and the gap comprises at least three concentric annular gaps communicating in series with one another. Therefore, in at least one gap, the outside of a double cylinder rotates and Taylor vortices are not formed therein. Thus, it is possible to provide a bearing mechanism which is highly effective in preventing the leakage of a liquid medium, as well as an X-ray tube having such a bearing mechanism.

Further objects and advantages of the present invention will be apparent from the following description of the preferred embodiments of the invention as illustrated in the accompanying drawings.

### BRIEF DESCRIPTION OF THE DRAWINGS

FIG. 1 is a diagram showing an example of construction of an X-ray tube in the best mode for carrying out the present invention;

FIG. 2 is a diagram showing an example of construction of a principal portion of bearing mechanism in the best mode for carrying out the present invention;

FIG. 3 is a diagram showing another example of construction of a bearing mechanism in the best mode for carrying out the present invention;

FIG. 4 is a diagram showing another example of construction of an X-ray tube in the best mode for carrying out the present invention; and

FIG. 5 is a diagram showing a further example of construction of an X-ray tube in the best mode for carrying out the present invention.

### DETAILED DESCRIPTION OF THE INVENTION

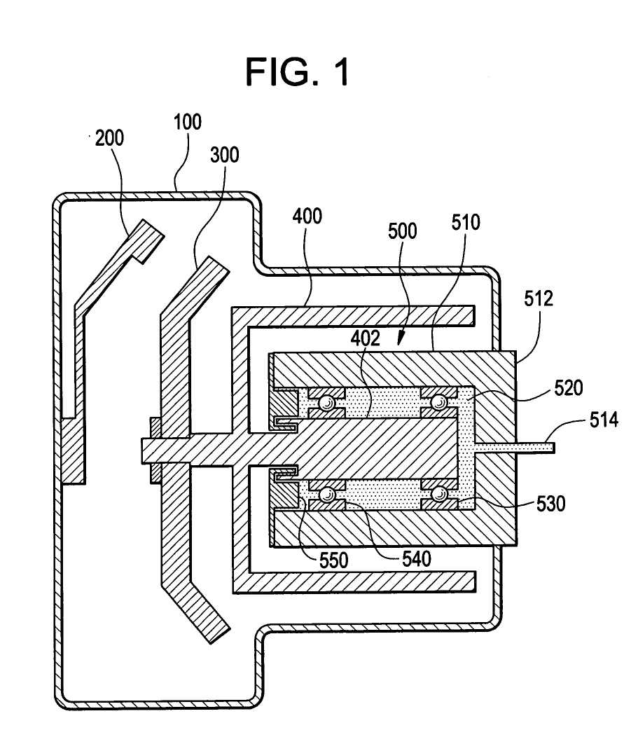

The best mode for carrying out the present invention will be described with reference to the drawings, provided the present invention is not limited to the base mode. FIG. 1 is a longitudinal sectional view showing a schematic construction of an example of an X-ray tube according to the present invention. This X-ray tube is an example of the best mode for carrying out the present invention. By the construction of this X-ray tube there is shown an example of the best mode for carrying out the present invention with respect to the X-ray tube.

As shown in FIG. 1, the X-ray tube includes, within a vacuum vessel 100, a cathode 200, an anode 300, a rotor 400 integral with the anode 300, and a bearing mechanism 500 for supporting a shaft 402 of the rotor 400.

The vacuum vessel 100 is formed of an X-ray transmitting material such as, for example, glass and the interior thereof is vacuum. Within the vacuum vessel 100, the cathode 200 and the anode 300 are opposed to each other. A high voltage is applied between the cathode 200 and the anode 300. Electrons of the cathode 200 accelerated by this voltage impinge on the anode 300 to generate X-ray.

The anode 300 is generally in the shape of a disc and is united with the rotor 400 which is generally cylindrical through the shaft 402. The rotor 400 is, for example, a rotor of an induction motor. The rotor 400 is excited by a stator coil (not shown) disposed outside the vacuum vessel 100 and rotates integrally with the anode 300 through the shaft 402. The shaft 402 is supported inside the rotor 400 in a cantilevered fashion by the bearing mechanism 500, whereby bearings can be concentrated to one place.

A description will now be given about the bearing mechanism 500. The bearing mechanism 500 is an example of the best mode for carrying out the present invention. By the construction of this mechanism there is shown an example of the best mode for carrying out the present invention with respect to the bearing mechanism.

The bearing mechanism 500 has a generally cylindrical case 510. The case 510 has a bottom 512 which is exposed to the exterior of the vacuum vessel 100. A plug 514 capable of being closed is provided in the bottom 512 and the interior of the case 510 is filled with a liquid metal 520 introduced through the plug 514. The liquid metal is superior in both thermal and electric conductivities and is suitable as a fill material in the bearing mechanism.

As the liquid metal there is used, for example, gallium or an alloy thereof. The liquid metal 520 functions as a heat transfer medium for allowing heat which has been conducted from the anode 300 to the shaft 402 to escape through the case 510. The liquid metal 520 also functions as an electrical conduction medium for conducting a high voltage supplied from the exterior of the X-ray tube to the anode 300 through the shaft 402. Gallium or an alloy thereof is also employable as a lubricant.

In the interior of the case 510 there are disposed two rolling bearings 530 and 540 at a predetermined spacing. The shaft 402 is supported rotatably by the rolling bearings 530 and 540. For example, ball bearings are used as the rolling bearings 530 and 540. With the rolling bearings, it is possible to enhance the mechanical strength of the shaft support portion.

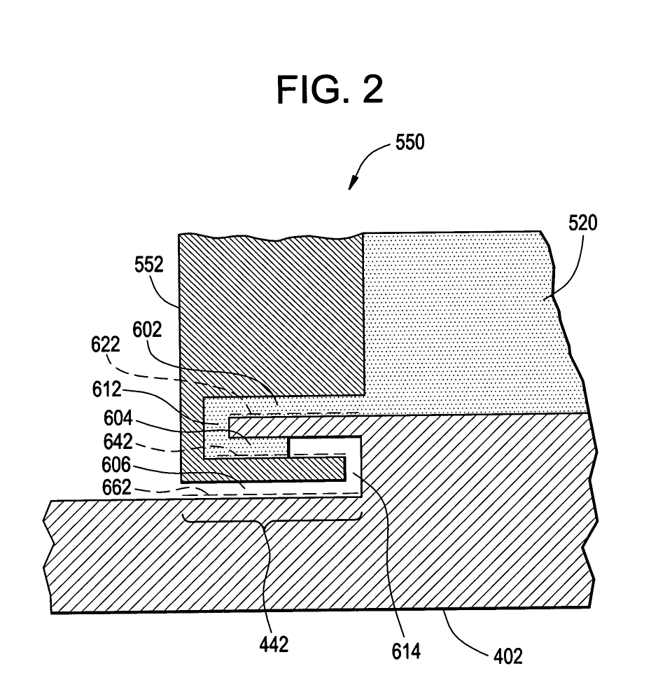

A plain bearing 550 is disposed at an end of the case 510 on the side opposite to the bottom 512. FIG. 2 shows an example of construction of a principal portion of the plain bearing 550 on a larger scale. In the plain bearing 550, as shown in FIG. 2, a bearing 552 and a corresponding journal 442 of the shaft 402 are intricate alternately axially, whereby a bent gap is formed between the bearing 552 and the journal 442.

The gap is constituted by a combination of three concentric annular gaps 602, 604, 606 and two concentric annular gaps 612, 614 which provide series communications among those three gaps. The distance from the axis of the shaft 402 is larger in the order of gaps 602, 604 and 606. One ends of the gaps 602 and 604 are in communication with each other through the gap 612 and opposite ends of the gaps 604 and 606 are in communication with each other through the gap 614.

The gaps 602, 604 and 606 constitute so-called radial bearing portions respectively, while the gaps 612 and 614 constitute so-called thrust bearing portions respectively. The gaps 602, 604 and 606 will hereinafter be referred to also as radial bearing portions and the gaps 612 and 614 as thrust bearing portions.

The spacing between the bearing 552 and the journal 442 in the radial bearing portion 602 is, for example, 30 to 50 μm. The spacing between the bearing 552 and the journal 442 in each of the radial bearing portions 604 and 606 is 50 μm for example. The spacing between the bearing 552 and the journal 442 in each of the thrust bearings 612 and 614 is 100 μm for example.

The liquid metal 520 gets into the thus-bent bearing portion. FIG. 2 shows a state in which the liquid metal 520 has entered halfway of the radial bearing portion 604 from the radial bearing portion 602 through the thrust bearing portion 612. The liquid metal 520 having entered the bearing portions 602, 612 and 604 functions also as lubricant.

In the radial bearing portion 602 there is formed a pumping groove 622 on the shaft 402 side. The pumping groove 622 is a spiral groove formed spirally in the surface of the shaft 402. The direction of the spiral is a direction of pushing back the liquid metal 520 under a pumping action created with rotation of the shaft 402.

In the radial bearing portion 604 there is formed a pumping groove 642 on the bearing 552 side. The pumping groove 642 is a spiral groove formed spirally in the surface of the bearing 552. The direction of the spiral is a direction of pushing back the liquid metal 520 under a pumping action created with rotation of the shaft 402.

In the radial bearing portion 606 there is formed a pumping groove 662 on the shaft 402 side. The pumping groove 662 is a spiral groove formed spirally in the surface of the shaft 402. The direction of the spiral is a direction in which the liquid metal 520 which has entered the radial bearing portion 606 is pushed back under a pumping action created with rotation of the shaft 402.

In the radial bearing portion 602, since the shaft 402 rotates inside the bearing 552, there exists a relation in which the inside of a double cylinder rotates. In the radial bearing portion 602, therefore, it is possible that Taylor vortices will be formed in the liquid metal 520, causing disturbance of the layer of the liquid metal 520 and diminishing the liquid metal pushing-back force by the pumping groove 622, with consequent leakage of the liquid metal 520 up to the radial bearing portion 604.

On the other hand, in the radial bearing portion 604, since the shaft 402 rotates outside the bearing 552, there exists a relation in which the outside of a double cylinder rotates. In the radial bearing portion 604, therefore, Taylor vortices are not formed in the liquid metal 520. Consequently, disturbance of the layer of the liquid metal 520 does not occur, and coupled with the pushing-back action of the pumping groove, the leakage of the liquid metal 520 is prevented. The pumping groove 642 is not essential and may be omitted.

In the radial bearing portion 606, the shaft 402 rotates inside the bearing 552 and there exists a relation in which the inside of a double cylinder rotates. However, since the distance of the radial bearing portion 606 from the axis of the shaft 402 is the shortest, the peripheral velocity of the shaft 402 is relatively low and therefore Taylor vortices are difficult to occur even if the liquid metal 520 gets into this portion. Thus, even with the liquid metal 520 getting into this portion, the pushing-back action of the pumping groove 622 is carried out effectively.

In this way leakage of the liquid metal 520 is prevented mainly by the radial bearing portion 604, and coupled with the leakage preventing effect of the radial bearing portion 606, the prevention of leakage of the liquid metal 520 is effected to a perfect extent. That is, the plain bearing functions also as a sealing element for the liquid metal 520. Consequently, there is no fear of entry of the liquid metal 520 into the vacuum vessel 100, nor is there any fear of impairment in stability of the anode voltage.

Since the leakage of the liquid metal 520 is prevented by the above functions of the radial bearing portions 604 and 606, the gap between the bearing 552 and the journal 442 can be made larger than in the prior art and hence it becomes easier to fabricate the plain bearing 550.

Further, since the plain bearing 550 is constituted separately from the rolling bearings 530 and 540, the liquid metal 520 present in the gap of the plain bearing 550 is not disturbed by the rotation of balls in the rolling bearings 530 and 540. This also contributes to enhancing the sealing effect of the plain bearing 550.

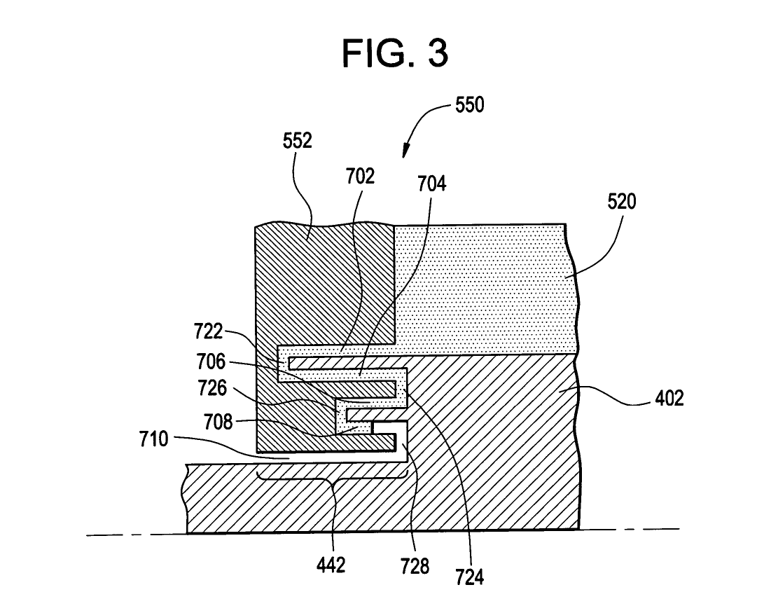

FIG. 3 shows another example of construction of a principal portion of the plain bearing 550 on a larger scale. According to the construction of the plain bearing 550 illustrated in FIG. 3, a bearing 552 and a journal 442 are further intricate, whereby a gap having an increased number of bends is formed between the bearing 552 and the journal 442.

The gap is constituted by a combination of five concentric annular gaps 702, 704, 706, 708, 710 and four concentric annular gaps 722, 724, 726, 728 which provide series communications among those five gaps. The distance from the axis of the shaft 402 is larger in the order of gaps 702, 704, 706, 708 and 710. One ends of the gaps 702 and 704 are in communication with each other through the gap 722 and opposite ends of the gaps 704 and 706 are in communication with each other through the gap 724. Likewise, one ends of the gaps 706 and 708 are in communication with each other through the gap 726, and opposite ends of the gaps 708 and 710 are in communication with each other through the gap 728.

The gaps 702, 704, 706, 708 and 710 constitute so-called radial bearing portions respectively, while the gaps 722, 724, 726 and 728 constitute so-called thrust bearing portions respectively.

In the plain bearing 550 of such a construction, a relation wherein the outside of a double cylinder rotates is valid in each of the radial bearings 704 and 708. Thus, the leakage of the liquid metal 520 is prevented at two places, whereby the leakage preventing effect is further improved. Besides, as a result of a further decrease of the peripheral velocity caused by a decrease in radius of the shaft 402 in the innermost radial bearing portion 710, Taylor vortices become more difficult to occur in this portion, thus contributing to the improvement of the leakage preventing effect.

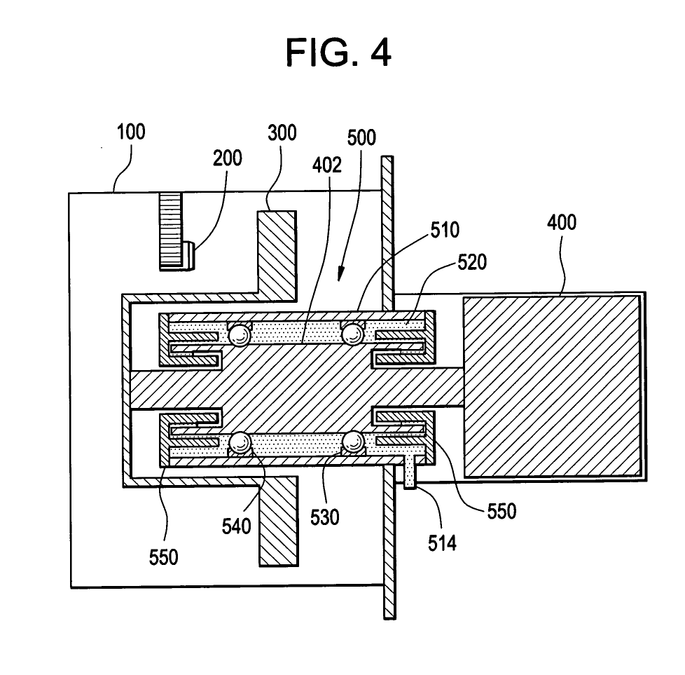

FIG. 4 is a longitudinal sectional view showing a schematic construction of another example of an X-ray tube. This X-ray tube is an example of the best mode for carrying out the present invention. By the construction of this X-ray tube there is shown an example of the best mode for carrying out the present invention with respect to the X-ray tube.

In FIG. 4, the same portions as in FIG. 1 are identified by the same reference numerals as in FIG. 1, and explanations thereof will be omitted. In this X-ray tube, an anode 300 and a rotor 400 are provided at both ends of a shaft 402. A portion of the shaft 402 located intermediate between the anode 300 and the rotor 400 is supported by a bearing mechanism 500. That is, the bearing mechanism 500 supports the shaft 402 in a straddled fashion, whereby a load can be dispersed.

The bearing mechanism 500 includes plain bearings 550 on the anode 300 side and the rotor side 400, respectively, with a liquid metal 520 being sealed into a case 510. The structure of the plain bearings 550 is the same as that shown in FIG. 2, having a sealing function for the liquid metal 520. The plain bearing shown in FIG. 3 may be used as each of the plain bearings 550.

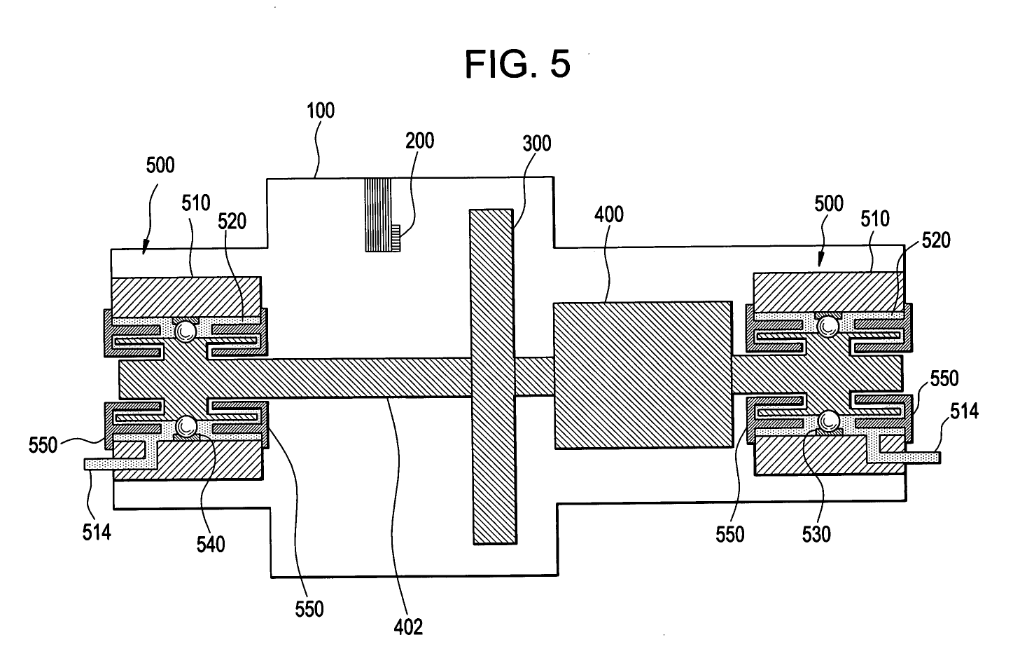

FIG. 5 is a longitudinal sectional view showing a schematic construction of a further example of an X-ray tube. This X-ray tube is an example of the best mode for carrying out the present invention. By the construction of this X-ray tube there is shown an example of the best mode for carrying out the present invention with respect to the X-ray tube.

In FIG. 5, the same portions as in FIG. 1 are identified by the same reference numerals a sin FIG. 1, and explanations thereof will be omitted. In this X-ray tube, both ends of a shaft 402 are supported by a pair of bearing mechanisms 500, and an anode 300 and a rotor 400 are provided at an intermediate portion of the shaft 402. That is, the pair of bearing mechanisms 500 supports the shaft 402 in a straddled fashion.

The pair of bearing mechanisms 500 is provided with plain bearings 550 located at inside and outside positions respectively in a vacuum vessel 100. A liquid metal 520 is sealed into a case 510. The structure of each plain bearing 550 is the same as that shown in FIG. 2, having a sealing function for the liquid metal 520. The plain bearing shown in FIG. 3 may be used as each of the plain bearings 550.

Many widely different embodiments of the invention may be configured without departing from the spirit and the scope of the present invention. It should be understood that the present invention is not limited to the specific embodiments described in the specification, except as defined in the appended claims.

1. A bearing mechanism including a gap between a plain bearing and a shaft, with a liquid medium being present in the gap,
wherein the gap comprises at least three concentric annular gaps communicating in series with one another.

2. A bearing mechanism according to claim 1, wherein the shaft has a pumping groove formed in an outer periphery surface thereof at a position facing the gap.

3. A bearing mechanism according to claim 1, wherein the liquid medium is a liquid metal.

4. A bearing mechanism according to claim 3, wherein the liquid metal is gallium or an alloy thereof.

5. A bearing mechanism according to claim 1, further including a rolling bearing on the shaft at a position different from the position of the plain bearing.

6. An X-ray tube including, within a vacuum vessel, a cathode, an anode, a rotor integral with the anode, and a bearing mechanism which supports a shaft of the rotor,
wherein the bearing mechanism includes a gap between a plain bearing and the shaft, with a liquid medium being present in the gap, and
wherein the gap comprises at least three concentric annular gaps communicating in series with one another.

7. An X-ray tube according to claim 6, wherein the shaft has a pumping groove in an outer periphery surface thereof at a position facing the gap.

8. An X-ray tube according to claim 6, wherein the liquid medium is a liquid metal.

9. An X-ray tube according to claim 8, wherein the liquid metal is gallium or an alloy thereof.

10. An X-ray tube according to claims 6, further including a rolling bearing on the shaft at a position different from the position of the plain bearing.

11. An X-ray tube according to claims 6, wherein the bearing mechanism supports the shaft in a cantilevered fashion.

12. An X-ray tube according to claims 6, wherein the bearing mechanism supports the shaft in a straddled fashion.
